(19) United States
(12) Patent Application Publication
(10) Pub. No.: US 2016/0067649 A1
(43) Pub. Date: Mar. 10, 2016

(54) Process of Gas Containment

(71) Applicant: CARBON CYCLE LIMITED, Sutton, Surrey (GB)

(72) Inventor: David Charles Sevier, Surrey (GB)

(73) Assignee: Carbon Cycle Limited, Surrey (GB)

(21) Appl. No.: 14/786,912

(22) PCT Filed: Apr. 24, 2014
(86) PCT No.: PCT/EP2014/058410

§ 371 Date: Oct. 23, 2015

(30) Foreign Application Priority Data
Apr. 24, 2013 (GB) 1307368.9

(51) Int. Cl. B01D 53/14; B01D 53/18

(52) U.S. Cl. CPC B01D 53/1425; B01D 53/1475; B01D 53/1487; B01D 53/18

(57) ABSTRACT

A process for capturing a target gas from a flowing gas mixture by use of at least a pair of capture and release sections together with a discharge section is described. The at least one pair of capture and release sections includes a target gas capture section and a target gas release section in fluid communication with one another. The target gas discharge section is in fluid communication with the target gas capture section. The capture, release and discharge sections have a high surface area medium and a fluid contained therein, and include a fluid entry point at a first end and a collection tank at a second end. The process comprises the steps of: directing a gas mixture through the target gas release section followed by the target gas capture section, wherein the fluid contained within the pair of capture and release sections allows for the target gas to be contained within a defined area between the capture and release sections; directing fluid through a first recirculation path from the collection tank of the target gas capture section to the entry point of the target gas release section and directing fluid from the collection tank of the target gas release section to the entry point of the target gas capture section, thereby recycling the fluid. The pair of capture and release sections include a concentration gradient of at least one of the target gas and the fluid. Further steps are: directing the fluid through a flow path, from the collection tank of the target gas capture section, heating the fluid and passing it through the discharge section to thereby release the target gas from the fluid within the discharge section due to the reduced solubility; and directing the fluid depleted of the target gas through a second recirculation path from the collection tank of the discharge section, and then to the entry point of the capture section. An apparatus is also disclosed.

### BACKGROUND OF THE INVENTION

The described invention is a process and an apparatus for containing within a defined area, apparatus or building, a target gas or gases within a flowing gas such that the target gas or gases do not escape the defined area except in trace quantities. The process and apparatus enable containment of the target gases, rather than relying on chemically binding the target gases by reaction to chemical salts, as they move out of the area that the target gases are contained in.

An example of a prior art process that chemically binds target gases would be to scrub ammonia gas leaving a process by passing over a high surface area sulphuric acid solution which would react with the ammonia to form ammonium sulphate. It would be desirable to simply contain the target gas or gases within a defined area.

The ability to contain a target gas within a flowing gas stream is highly useful and hither to has not been possible without use of chemically binding, or use of pressure and/or high temperatures. The process outlined in patent publication nos. US2012/0111189A and US2002/0014154A are examples of gas containment systems that rely on pressure input for gas containment and recovery. The process of US2002/0014154A also requires a high temperature coating process. Other prior art systems and processes rely on high operating temperature. Such systems are energy intensive and have significant operational costs associated with them.

The ability to contain significant amounts of a target gas within a flowing gas stream using a low energy method that does not require chemical binding, pressure swings or high temperatures to function makes a number of new processes viable. Previously the use of highly volatile carbon sorbents such as methanol could only be used at cold temperatures of −40° C. for carbon capture due to the high vapour pressure of methanol at higher temperatures. It would be desirable to mitigate this disadvantage.

Another issue is that currently there are no low energy methods to prevent water loss from greenhouses and other water-stressed areas as a result of air exchange. It would also be desirable to address this problem.

### SUMMARY OF THE INVENTION

According to a first aspect of the invention, there is provided a process for capturing a target gas from a flowing gas mixture by use of at least a pair of capture and release sections together with a discharge section, said at least one pair of capture and release sections including a target gas capture section and a target gas release section in fluid communication with one another, said target gas discharge section being in fluid communication with the target gas capture section, the capture, release and discharge sections having a high surface area medium and a fluid contained therein and including a fluid entry point at a first end and a collection tank at a second end, said process comprising the steps of: directing a gas mixture through the target gas release section followed by the target gas capture section, wherein the fluid contained within the pair of capture and release sections allows for the target gas to be contained within a defined area between the capture and release sections; directing fluid through a first recirculation path from the collection tank of the target gas capture section to the entry point of the target gas release section and directing fluid from the collection tank of the target gas release section to the entry point of the target gas capture section, thereby recycling the fluid, said pair of capture and release sections including a concentration gradient of at least one of the target gas and the fluid; directing the fluid through a flow path, from the collection tank of the target gas capture section, heating the fluid and passing it through the discharge section to thereby release the target gas from the fluid within the discharge section due to the reduced solubility; and directing the fluid depleted of the target gas through a second recirculation path from the collection tank of the discharge section, and then to the entry point of the capture section.

Preferably, one or more further gases are captured. In some embodiments the flowing gas mixture is natural gas and carbon dioxide or methane and carbon dioxide, and carbon dioxide is the captured gas and the fluids used to capture the carbon dioxide comprise a solution of a target gas or gases contained by the process.

Advantageously, the discharged gas is directed through a series of capture sections that are in fluid connection with the target gas capture sections so that any target gas or gases that are discharged are removed such that a stream of captured gas or gases that is substantially free of the target gases is achieved.

Conveniently, one or more heat exchangers are placed between the gas capture section and the captured gas release section and/or between the captured gas release section and the target gas capture section to remove and recover heat. In other embodiments, the gas mixture may be at constant temperature and pressure.

In some embodiments, the fluid may comprise one of water, ammonia, methanol, ethanol or any other organic fluid and solutions thereof and, mixtures thereof. In some embodiments, the target gas may comprise one of ammonia, water vapour, CO2 or organic solvents.

Conveniently, a target gas is water vapour and the fluid is comprised of a solution that has a relative humidity which allows gas to be discharged at substantially the same given percent relative humidity at which it entered the process.

In embodiments where a further concentration of a captured gas is useful, the process may further comprise directing the gas through a further flow path in which the concentration of a gas to be captured is increased. Advantageously, the further flow path may comprise one or more thermal swings, arranged to increase the concentration of the gas to be captured. Conveniently, the one or more thermal swings may be provided using fluid in one or more further recirculation paths.

Preferably, the process may further comprise directing the gas from the further flow path into the gas capture section, such that a stream of captured gas or gases that is substantially free of the target gases is achieved.

According to a second aspect of the invention, there is provided an apparatus for capturing a target gas from a flowing gas mixture, comprising: at least a pair of capture and release sections and a discharge section, said at least one pair of capture and release sections including a target gas capture section and a target gas release section in fluid communication with one another, said target gas discharge section being in fluid communication with the target gas capture section, wherein the capture, release and discharge sections have a high surface area medium and a fluid contained therein and include a fluid entry point at a first end and a collection tank at a second end; a defined area between the capture and release sections, wherein the fluid contained within the pair of capture and release sections allows for the target gas to be contained within the defined area upon a gas mixture being directed through the target gas release section followed by the target gas capture section; a first recirculation path through which fluid can be directed from the collection tank of the target gas capture section to the entry point of the target gas release section and from the collection tank of the target gas release section to the entry point of the target gas capture section, thereby recycling the fluid, said pair of capture and release sections including a concentration gradient of at least one of the target gas and the fluid; a flow path through which fluid can be directed from the collection tank of the target gas capture section through the discharge section; a means for heating the fluid in the discharge section to thereby release the target gas from the fluid within the discharge section due to the reduced solubility; and a second recirculation path from the collection tank of the discharge section to the entry point of the capture section, through which fluid depleted of the target gas can be directed.

Preferably, the apparatus is arranged to capture one or more further gases. In some embodiments, the apparatus is arranged to capture a target gas from a flowing gas mixture which is natural gas and carbon dioxide or methane and carbon dioxide, and wherein carbon dioxide is the captured gas and the fluids used to capture the carbon dioxide comprise a solution of a target gas or target gases contained by the process.

Advantageously, the apparatus further comprises a series of capture sections that are in fluid connection with the target gas capture sections, through which the discharged gas can be directed so that any target gas or gases that are discharged are removed such that a stream of captured gas or gases that is substantially free of the target gases is achieved.

Conveniently, the apparatus further comprises one or more heat exchangers placed between the gas capture section and the captured gas release section and/or between the captured gas release section and the target gas capture section to remove and recover heat. In other embodiments, the apparatus is arranged to maintain the gas mixture at constant temperature and pressure.

In some embodiments, the fluid may comprise one of water, ammonia, methanol, ethanol or any other organic fluid and solutions thereof and, mixtures thereof. In some embodiments, the target gas may comprise one of ammonia, water vapour, CO2 or organic solvents.

In some embodiments, a target gas is water vapour and the fluid is comprised of a solution which allows gas to be discharged at substantially the same given percent relative humidity at which it entered the apparatus.

In embodiments where a further concentration of a captured gas is useful, a further flow path may be arranged for gas to be directed through, such that the concentration of a gas to be captured is increased. Advantageously, the further flow path may comprise one or more thermal swings, arranged to increase the concentration of the gas to be captured. Preferably, the one or more thermal swings comprise a heat exchanger and a fluid recirculation path.

Advantageously, gas may be directed from the further flow path into the gas capture section, such that a stream of captured gas or gases that is substantially free of the target gases is achieved.

Conveniently, the further flow path may comprise a connection between the discharge section and the one or more thermal swings such that gas can be injected into the one or more thermal swings to increase concentration of a gas to be captured, such as carbon dioxide, moving through the thermal swings.

According to a third aspect of the invention, there is provided a process for capturing a target gas from a flowing gas mixture by use of at least a pair of capture and release sections together with a discharge section, said at least one pair of capture and release sections including a target gas capture section and a target gas release section in fluid communication with one another, said target gas discharge section being in fluid communication with the target gas capture section, the capture, release and discharge sections having a high surface area medium and a fluid contained therein and including a fluid entry point at a first end and a collection tank at a second end, said process comprising: directing a gas mixture through the target gas release section followed by the target gas capture section, wherein a target gas is water vapour and the fluid contained within the pair of capture and release sections is comprised of a solution which allows for water vapour to be contained within a defined area between the capture and release sections; directing fluid through a first recirculation path from the collection tank of the target gas capture section to the entry point of the target gas release section and directing fluid from the collection tank of the target gas release section to the entry point of the target gas capture section, thereby recycling the fluid, said pair of capture and release sections including a concentration gradient of at least one of water vapour and the fluid; directing the fluid through a flow path, from the collection tank of the target gas capture section, and passing it through the discharge section to thereby release water vapour from the fluid within the discharge section; and directing the fluid depleted of the water vapour through a second recirculation path from the collection tank of the discharge section and then to the entry point of the capture section, wherein gas is discharged at substantially the same given percent relative humidity at which the gas mixture entered the process.

According to a fourth aspect of the present invention, there is provided an apparatus for capturing a target gas from a flowing gas mixture, comprising: at least a pair of capture and release sections and a discharge section, said at least one pair of capture and release sections including a target gas capture section and a target gas release section in fluid communication with one another, said target gas discharge section being in fluid communication with the target gas capture section, wherein the capture, release and discharge sections have a high surface area medium and a fluid contained therein and include a fluid entry point at a first end and a collection tank at a second end; a defined area between the capture and release sections, wherein a target gas is water vapour, and wherein the fluid contained within the pair of capture and release sections allows for water vapour to be contained within the defined area upon a gas mixture being directed through the target gas release section followed by the target gas capture section; a first recirculation path through which fluid can be directed from the collection tank of the target gas capture section to the entry point of the target gas release section and from the collection tank of the target gas release section to the entry point of the target gas capture section, thereby recycling the fluid, said pair of capture and release sections including a concentration gradient of at least one of water vapour and the fluid; a flow path through which fluid can be directed from the collection tank of the target gas capture section through the discharge section; and a second recirculation path from the collection tank of the discharge section to the entry point of the capture section, through which fluid depleted of water vapour can be directed, wherein gas is discharged at substantially the same given percent relative humidity at which the gas mixture entered the process.

Thus in some embodiments, water vapour can be contained whilst capturing a gas such as carbon dioxide, without the need for a large energy input.

This invention will make possible the use of high vapour pressure carbon capture sorbents under high vapour conditions. This has significant benefits. A review of organic solvents that demonstrate good solubility towards carbon dioxide shows that all solvents that have good carbon dioxide solubility have significant vapour pressures outside of very cold conditions. This invention will make possible their use under non-cold conditions.

Equally, the ability to contain a target gas within a flowing gas stream can be used to contain water humidity within buildings or machines. In this way, the invention has significant application to conserve water loss from greenhouses that need to exchange air continuously to provide fresh carbon dioxide to the growing plants. Currently there are no low energy methods to prevent water loss from greenhouses as a result of air exchange. The ability to greatly reduce or eliminate water loss in water stressed areas is likely to have significant application as the world seeks to feed an increasing population.

### BRIEF DESCRIPTION OF THE DRAWINGS

FIG. 1 shows schematically an apparatus including an arrangement of linked absorption and desorption pairs of modules for capturing a target gas.

FIG. 2 shows schematically an apparatus including an arrangement which can be used to capture more than one gas.

FIG. 3 shows schematically an apparatus similar to FIG. 2, including an arrangement which can be used to increase the concentration of a captured gas.

### DESCRIPTION OF THE PREFERRED EMBODIMENTS

Embodiments of the invention will now be described, by way of example only, with reference to the above-mentioned drawings.

Principals of Containment

The process works by using a system of linked absorption and desorption pairs. If a gas is less than saturated within a liquid, the liquid will actively absorb more gas if it is available. Equally if a gas is over dissolved within a liquid, the liquid will actively give up gas until the dissolved gas within the liquid become in equilibrium with the gas above the liquid. This will work for any gas that has solubility in any fluid. This invention creates conditions where fluids that are depleted in a gas are brought to conditions where there is an excess of a gas such that the gas can be absorbed into the fluid. The gas-enriched liquid is then taken to conditions where the gas in the fluid is over-saturated in comparison to the surrounding gas, such that some of the dissolved gas seeks to return to free gas and is released from the fluid. The gas-depleted fluid then returns back to conditions where it can absorb more gas. This is achieved by interlinking gas containment pairs.

Figure one shows the basic configuration of this invention's gas containment. Gas is contained in a central area. Sections release increasing amounts of gas into the gas stream flowing toward the central area where the gas is being contained. Sections that absorb gas remove the target gas from the gas stream leaving the central section, pairs of linked gas containment sections, arranged in an outward expanding fashion, create a gradient of falling concentration of gas until only trace amounts of gas leave the containment process.

Process of Containment

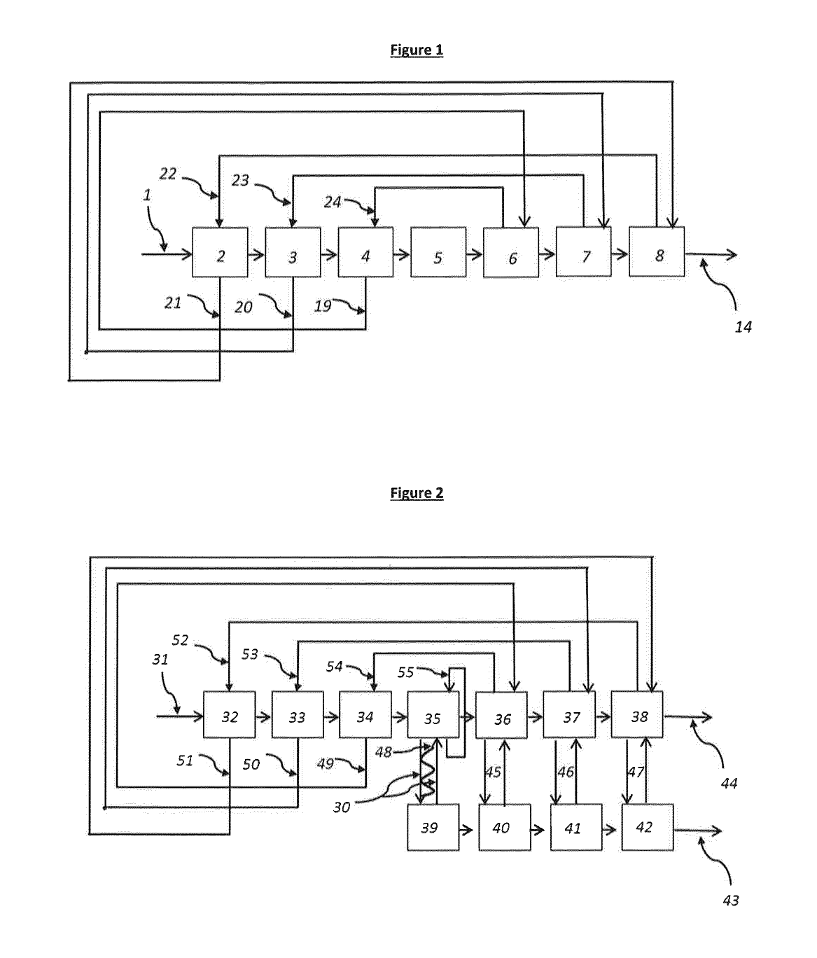

In figure one, gas is contained in a central section 5. Examples of gases that can be contained include ammonia, water vapour and organic solvents with high vapour pressures such as methanol or ethanol. Virtually any gas can be usefully contained as long as a fluid in which the gas has solubility in is used. In FIG. 1, items 2, 3, 4, 6, 7 and 8 are sections or modules where a fluid that the target gas to be contained has solubility in is spread into films, fine droplets, foams or individual bubbles such that a high surface area of the fluid is created to allow the absorption or release of the target gas into or from the absorbing fluid.

In all described sections, the fluid is spread into a high surface area though either creating sprays, individual bubbles, foam or spreading across fill packs. In all cases the fluid is first spread out to absorb or release the target gas and then falls into a collecting sump that then leads to a pump which can then pump the fluid to the next position required. However, the sections are shown as boxes and the pumps are omitted for clarity of the figures.

The fluid is collected into the collection sump after absorbing or desorbing the target gas in each section. A target gas absorption section includes sections 6, 7 and 8 to absorb target gas. A target gas release section includes sections 2, 3 and 4 to release the target gas or gases. The target gas absorption and target gas release sections are arranged in connected pairs and are named in the following accordingly. A first (outermost) target gas release section 2 is fluid connected to a first (outermost) target gas capture section 8 via connection pipes 21 and 22. A second (middle) target gas release section 4 is fluid connected to a second (middle) target gas capture section 6 via connection pipes 19 and 24. A third (innermost) target gas release section 3 is fluid connected to a third (innermost) target gas capture section 7 via connection pipes 20 and 23.

In operation, a gas mixture is passed into the target gas release section at the first target gas release section 2, as indicated by reference numeral 1. The target gas leaves the central section 5 and passes to the third target gas capture section 6, where some of the target gas is dissolved into the fluid. The fluid that is collected after absorbing some of the target gas is passed to the third target gas release section 4 via the connection pipe 24, where the gas that contacts the fluid has a lower concentration of the target gas. This means that the dissolved gas within the fluid will be out of equilibrium with the target gas within the gas phase and a proportion of the dissolved target gas will be released and become a free gas. The fluid with a decreased amount of target gas dissolved in it is collected and then passes via the connection pipe 19 back to the third target gas capture section 6, where it is used again to capture more of the target gas. This is repeated with the paired second sections 3 and 7, where the collected fluid from the second target gas release section 3 is passed back to the second target gas capture section 7 by the connection pipe 20 and in the first target gas release section 2, where the collected fluid is passed back to the first target gas capture section 8 by the connection pipe 21. As the moving gas moves from the third target gas capture section 6 to the second target gas capture section 7 and then to the first target gas capture section 8 and then out of the process, a gradient of target gas is created such that the concentration of the target gas decreases moving outward from the central section 5 towards the first section 8. Equally, as the gas enters the process at 1 and moves through the first target gas release section 2 to the second target gas release section 3 than to the third target gas release section 4, the concentration of the target gas increases.

Thus in terms of concentration of the target gas, the gas entering the process at 1 is substantially the same as the gas leaving the process at 14.

By choice of the correct absorption fluid, it is possible to contain more than one gas within the process. For example, if methanol is used as the fluid, both methanol and water vapour can be contained. Another example would be to use propylene glycol water solutions to contain water and ammonia vapour. A further example would be to use monoethylene glycol water solutions to contain water and ammonia vapour. Other examples will be apparent to the skilled person.

Containment of Ammonia

In our experimental work on containing ammonia gas in a flowing air stream operating at approximately 1 m/s, we passed the flowing gas perpendicular to fill packs that had falling water being pumped across the top of the fill packs, from where the resulting fluid was allowed to fall into a collection sump. We found that under good water distribution conditions, that a typical absorption section would reduce the concentration of ammonia by 98% or better. The release section would typically have an ammonia concentration within the fluid 20% less than the fluid leaving the capture section. An illustration of ammonia containment is outlined below. The sections are arranged next to each other to show pairing as reflected in FIG. 1 moving outward from the central section 5.

| | Ammonia | | | Ammonia | |
|---|---|---|---|---|---|
| | Concentration | | | Concentration | |
| Section | Leaving Section | | Section | Leaving Section | |
| 5 | 10,000 | ppm | | | |
| 6 | 200 | ppm | 4 | 160 | ppm |
| 7 | 3.2 | ppm | 3 | 4.0 | ppm |
| 8 | 0.08 | ppm | 2 | 0.06 | ppm |

The number of paired sections shown in the example and in FIG. 1 is illustrative only. Other gases may need more or fewer paired sections. The exact number of paired sections will be dependent upon conditions such as temperature, speed of the gas, solubility properties of the target gas in the fluid chosen, etc. It can be seen from the table that the concentration of ammonia at the first target gas release section 2 is substantially the same as that leaving the first target gas capture section 8.

Containment of Humidity

The outlined process has a number of useful applications that are quite diverse. One example is to use the process to contain humidity within buildings, greenhouses or airplanes. Humidity control is particularly important in computer data centres during the winter months in cold regions where low humidity air can cause problems with static discharge. Minimum levels of humidity have to be maintained while maintaining regular air changes as required for human health within the buildings. This can require evaporating reasonable volumes of water to replace lost humidity that leaves the buildings. The outlined invention can be used to contain humidity within a building, thereby saving the cost of evaporation and supply of water which would otherwise be incurred.

To contain humidity, a suitable fluid is chosen that has a relative humidity greater than that of the incoming air. Relative humidity refers to the property of a fluid or solid to absorb or release moisture from the air. For example, if a fluid is used that has 50% relative humidity, and the outside air is 30% humidity, the fluid will donate humidity to the passing air so that the humidity of the air rises. If sufficient contact with the fluid occurs, the air will gain sufficient humidity so that it becomes in equilibrium with the fluid and has a humidity of 50%. Equally if air that has a humidity of greater than 50% as it passes over the fluid, the fluid will actively absorb humidity from the air until the air becomes in equilibrium with the fluid and has a humidity of 50%.

Examples of absorption fluids that can be adjusted to have desired relative humidities are solutions of salts such as sodium chloride or solutions of soluble organic compounds such as monoethylene glycol. There are standard, well-known relative humidity calculation methods that can be used to determine the concentration of the salt or organic compound required to create a fluid with the desired relative humidity. For example, a four molar solution of sodium acetate has a relative humidity of 83.35% and a six molar solution has a relative humidity of 75.6%.

Higher concentration solutions of salts or organic compounds also exert a high osmotic pressure and can be biostatic to bacteria, mould, yeast, fungus and algae. Thus by choosing an appropriate concentration of the salt solution, biological problems which could cause health problems such as legionella can be prevented or mitigated.

An example of an application of humidity containment would be to use solutions of monoethylene glycol to contain humidity of 59.6% within a building. Referring to FIG. 1, 32% humid air would enter the building at 1 and pass over a monoethylene glycol solution in section two that had a relative humidity greater than 32% so that water vapour was given up. The air would pass through the sections until section four where the monoethylene glycol solution would have a concentration slightly lower than 70%. 70% monoethylene glycol has a relative humidity of 59.6%. The air that leaves target gas release section 4 and enters the building (labelled as section 5 in FIG. 1) will have a humidity of 59.6% or close to this value. How close to the equilibrium of 59.6% that the air achieves will be dependent upon the surface area of the fluids in the sections and the air speed. The air then leaves the building where the humidity is usefully contained and passes through the target gas capture sections six to eight. The air leaving the target gas capture section eight has a humidity of 32%. Section eight contains an 88% monoethylene glycol solution that has a relative humidity of 32%. In this way, humidity at a useful and comfortable level is maintained within the building at (at the central section 5 in the figure), which thereby has continuous and regular air changes.

The outlined principals can be used to contain gases such as water humidity within any structure such as a building or machine such as an airplane.

Humidity Management and Carbon Capture

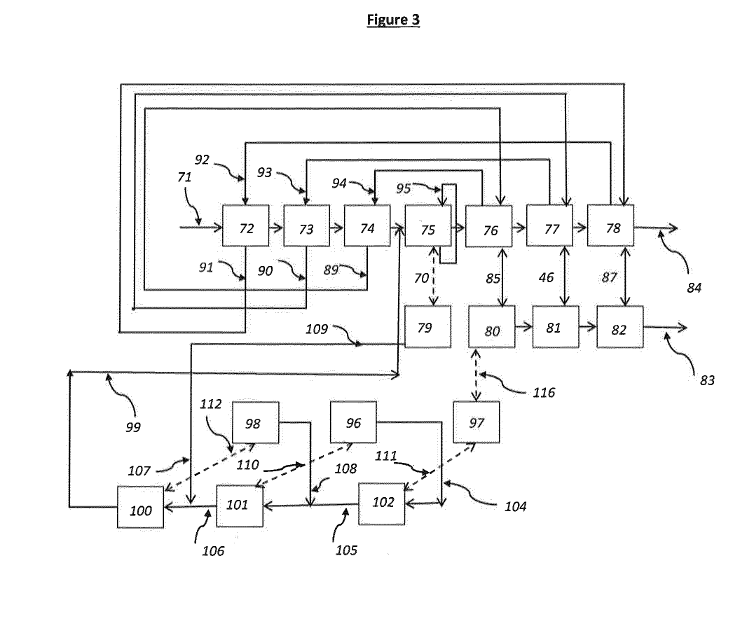

A very useful application of gas containment is to contain a carbon dioxide sorbent that has a vapour pressure such that sorbent gas is released into a moving gas stream. An example of this would be to use an alcohol such as ethanol or methanol as a sorbent to capture carbon dioxide from a moving gas stream. The gas stream may be a mixture of carbon dioxide and nitrogen, although the process would work for other gas streams. The process would work for any sorbent. With reference to FIG. 2, an alcohol solution, in this case methanol, is circulated within the central section 35, as indicated by a fluid loop 55. The alcohol is made into a high surface area by individual bubbles, foam, fine sprays or by spreading across a fill pack. The released alcohol vapour is absorbed by the target gas capture sections 36, 37 and 38 and from the carbon dioxide stream from the target gas capture sections 40, 41 and 42 and collected alcohol vapour is released in the target gas release sections 32, 33, and 34. In this way the alcohol vapour is contained within the process. A stream of high concentration carbon dioxide leaves the process out of the target gas capture section 42 at 43 with little or no alcohol vapour.

The core functionality of vapour containment corresponds to that outlined in FIG. 1. In FIG. 2, a first target gas capture section 38 corresponds to the first target gas capture section 8 in FIG. 1, a second target gas capture section 37 corresponds to the second target gas capture section 7 in FIG. 1 and a third target gas capture section 36 corresponds to the third target gas capture section 6 in FIG. 1. In FIG. 2, a first target gas release section 32 corresponds to the first target gas release section 2 in FIG. 1, a second target gas release section 33 corresponds to the second target gas release section 3 in FIG. 1 and a third target gas release section 34 corresponds to the third target gas release section 4 in FIG. 1.

In FIG. 2, a central section 35 corresponds to the central section 5 in FIG. 1. The central section 35 is fluid-connected to a discharge section 39. The third target gas capture section 36 is fluid-connected to a fourth target gas capture section 40. The second target gas capture section 37 is fluid-connected to a fifth target gas capture section 41. The first target gas capture section 38 is fluid-connected to a fifth target gas capture section 42.

An alternative configuration would be to connect the fourth target gas capture section 40 to the third target gas release section 34, the fifth target gas capture section 41 to the second target gas release section 33 and the sixth target gas capture section 42 to first target gas release section 32.

The alcohol concentration cannot be pure alcohol unless the gas that passes through the device is without humidity. In all situations where humidity is present, an alcohol/water solution is used or ends up being created by absorbing humidity from the gas stream. For example, 99% ethanol has a relative humidity of just 2.5%. Gas or air above this humidity will cause the ethanol to absorb water from the passing gas until it reaches humidity balance with the gas, unless a process to remove the captured humidity is implemented. The described issues of humidity absorption will apply to all solvent solutions that have a relative humidity and can absorb water.

The solubility of all gases decreases as the temperature of the liquid rises and gas solubility increases as the temperature falls, as predicted by Henry's Law. Carbon dioxide has relatively high solubility in alcohols such as methanol or ethanol. In this way, if gas at 15° C. is passed into the first target gas release section 32 and through the device as outlined in figure two, carbon dioxide will dissolve in the alcohol solution in the central section 35. If the alcohol solution is transferred to the discharge section 39 as shown in figure two and the temperature is raised (to 40° C. for example), the concentration of carbon dioxide within the alcohol solution in the discharge section 39 will be out of equilibrium with solubility of the gas within the fluid. This means that carbon dioxide will be released from the alcohol solution in the discharge section 39. If the alcohol solution is spread into a high surface area such as spreading the alcohol solution across a fill pack, it will facilitate the release of the carbon dioxide as the alcohol/water solution seeks equilibrium with the surrounding gas. This will also facilitate the release of water vapour.

The relative humidity above a solution generally remains the same regardless of temperature but the amount of water (absolute humidity) that a given value of relative humidity represents changes with temperature. For example, at 10° C., a relative humidity of 70% is equal to an absolute humidity of 6.58 g water/m³. At 50° C., 70% relative humidity represents an absolute humidity of 58.04 g water/m³. This means that taking fluid from the central section 35 to the discharge section 39 where the temperature is raised, will release captured water vapour from the fluid. In the central section 35, the fluid that falls into the collection sump is at or near humidity balance with the gas. In the discharge section 39, because the temperature is higher, the fluid falls out of humidity balance with the gas above the liquid and is oversaturated with water in ratio to the humidity above the fluid. This means that water will move from the liquid phase into the gas phase above the liquid. The fluid that returns to the central section 35 after releasing water vapour will therefore have reduced water content and have a lower relative humidity. This will cause the fluid to absorb humidity in the central section 35. If a heat exchanger, 30, is added between the central section 35 and the discharge section 39, heat can be conserved in the discharge section 39 to maintain conditions where carbon dioxide and water vapour are released. Heat is added to the fluid entering the discharge section 39 to make up for heat losses from the process, as no heat exchanger is perfect. Equally, the release of carbon dioxide, water and alcohol vapour will absorb heat and cool the fluid. Heat addition is required to make up this heat loss. The released gas from the discharge section 39 is transferred to the fourth target gas capture section 40 where alcohol and water vapour are captured by fluid that is transferred between the fourth target gas capture section 40 and the third target gas capture section 36. The captured alcohol vapour is eventually released in the third target gas release section 34. The captured water is released into the gas stream leaving the third target gas capture section 36. This same process is repeated as the gas moves through the fifth and sixth target gas capture sections 41 and 42 so that little or no alcohol vapour leaves the process at 43. Further heat recovery is possible if a heat exchanger is added between the discharge section 39 and the fourth target gas capture section 40.

If 60% humidity gas were to enter the process and a water/monoethylene glycol solution were used in the first, second and third target gas release sections 32, 33, 34, and the first, second and third target gas capture sections 36, 37 and 38, we would expect the concentration of the glycol to be somewhat less than 70% in the first sections 32 and 38. 70% monoethylene glycol has a relative humidity of 59.6%. The monoethylene glycol concentration would rise as you move to the centre of the process at central section 35, because the fluid in the central section 35 (for example ethanol) would absorb humidity from the gas stream and give up humidity in the discharge section 39. In this way, the gas at the exit from the central section 35 will have lower humidity. Ultimately, the concentration and the humidity drop across the central section 35 is dependent upon the recirculation rate between the central section 35 and the discharge section 39, because this defines the rate at which water is removed from the fluid in the central section 35. Lower water content fluids will have lower relative humidity and absorb humidity from the passing gas more strongly.

Ultimately any collected water is added back into the flowing gas stream in the first, second and third target gas capture sections 36, 37 and 38. The gas stream leaves the process from the first target gas capture section 38, as indicated by reference numeral 44. The humidity of the gas leaving the process at 44 will be the same as the humidity of the gas entering the process at 31 into the first target gas release section 32. Thus in this embodiment, water vapour is one of the target gases and is captured in the central section 35 and subsequently released out of the first target gas release section 38 at 44, whilst carbon dioxide is a captured gas. The captured carbon dioxide which exits the process from the sixth gas capture section 42 contains very little water vapour.

If gas that has low humidity is passed through the process, water vapour within the process is maintained by the fluid connections 45, 46 and 47 between the sections 40 to 36 (fourth and third target gas capture sections) and section 41 to 37 (fifth and second target gas capture sections) and section 42 to 38 (sixth and first target gas capture sections). In this way water vapour will be held within the process.

It should be noted that an advantage of the presently-described system over many prior art systems is that it can operate at convenient temperatures. The upper temperature used, 40° C. in this example, can be achieved by using readily-available waste heat from a power plant, because this is approximately the temperature at which waste heat is discharged. The system and process work equally at slightly lower temperatures, such as 35° C., which power plants may also discharge at. Thus heat in this temperature band is “free” and in essentially infinite supply and is usually lost as waste heat by dumping into a river or the ocean. Thus the invention is conveniently able to use this heat, thereby avoiding energy wastage. The lower temperature used, of approximately 15° C., is also readily achieved, since this is often approximately atmospheric temperature. This provides an advantage over prior art systems which can only use sorbents such as methanol at very low temperatures such as −40° C., because in the presently-described systems and processes, the volatility is contained.

One alternative sorbent is ethanol and in this case, the process would work similarly to that described above for a methanol sorbent. An alternative sorbent is ammonia. In this case, ammonia would be consumed and would need to be added continuously into the central section 35, either as a liquid or as a gas. Gypsum could be used with ammonia to capture carbon dioxide, as described in the applicant's co-pending international patent application publication no. WO 2012/013961.

In FIGS. 1 and 2, the sections are shown separately, but it is possible to have continuous sections that flow into one another as long as the fluid circulation between the linked pairs is kept from mixing with the adjoining sections and the collected fluid from each section falls into a separate sump that does not mix with surrounding sumps, so that a fluid gradient can be maintained.

Containment of a Gas and Increasing its Concentration

The concentration of carbon dioxide that is released by the heating of the carbon absorber (methanol in a preferred embodiment described in the following) is not pure and will generally be limited by the concentration of the carbon dioxide in the lower temperature gas flow and by the temperature differential between the capture gas stream and the carbon dioxide gas release. This can create the need in some applications to further concentrate the carbon dioxide to useful concentrations. This can be achieved by the configuration of apparatus that is shown in FIG. 3. This configuration is similar to the previously-described configuration of FIG. 2, but further process steps, involving directing the gas through a further flow path, are included to increase the concentrate of carbon dioxide.

The core functionality of vapour containment corresponds to that outlined in FIG. 2. In FIG. 3, a first target gas capture section 78 corresponds to the first target gas capture section 38 in FIG. 2, a second target gas capture section 77 corresponds to the second target gas capture section 37 in FIG. 2 and a third target gas capture section 76 corresponds to the third target gas capture section 36 in FIG. 2. A first target gas release section 72 corresponds to the first target gas release section 32 in FIG. 2, a second target gas release section 73 corresponds to the second target gas release section 33 in FIG. 2 and a third target gas release section 74 corresponds to the third target gas release section 34 in FIG. 2. In this embodiment, methanol is the fluid used as a carbon absorber.

In FIG. 3, a central section 75 corresponds to the central section 35 in FIG. 2. The central section 75 is fluid-connected to a discharge section 79, which corresponds to the discharge section 39 of FIG. 2, via a heat exchanger 70, which corresponds to the heat exchanger 30 of FIG. 2. The third target gas capture section 76 is fluid-connected to a fourth target gas capture section 80, which corresponds to the fourth target gas capture section 40 of FIG. 2. The second target gas capture section 77 is fluid-connected to a fifth target gas capture section 81, which corresponds to the fifth target gas capture section 41 of FIG. 2. Finally, the first target gas capture section 78 is fluid-connected to a sixth target gas capture section 82, which corresponds to the sixth target gas capture section 42 of FIG. 2.

There are six further sections, indicated by reference numerals 96, 97, 98, 100, 101 and 102, which are arranged in three pairs to provide a thermal swing functionality for further concentrating captured gas. The first further pair of sections are a first high section 98 and a first low section 100. The terms “high” and “low” are a shorthand way of distinguishing between the sections by reference to their relative temperatures, but these terms do not imply any particular absolute temperatures.

An output of the first low section 100 is connected by a pipe 99 to the input of the central section 75. It receives an input from the discharge section 79 via a pipe 109. The first low section 100 is fluid-connected to the first high section 98 across a thermal swing, provided by a heat exchanger 112.

The second further pair of sections are a second high section 96 and a second low section 101. An output of the second low section 101 is connected by a pipe 106 to form a “second” input to the first low section 100. In practical terms, the input from the pipe 109 is injected into the pipe 106, as indicated by reference numeral 107, such that a single input is provided to the first low section 100. The second low section 101 receives an input from the first high section 98 via a pipe 108. The second low section 101 is fluid-connected to the second high section 96, across a thermal swing, provided by a heat exchanger 110.

The third further pair of sections are a third high section 97 and a third low section 102. An output of the third low section 102 is connected by a pipe 105 to form a “second” input to the second low section 101. In practical terms, the input from the pipe 108 is injected into the pipe 105, such that a single input is provided to the second low section 101. The third low section 102 receives an input from the second high section 96 via a pipe 111. The third low section 102 is fluid-connected to the third high section 97. The third high section 97 is connected by a pipe and heat exchanger, as indicated by reference numeral 116, to the fourth target gas capture section 80.

In operation, the carbon absorber, which in this embodiment is methanol, becomes saturated with carbon dioxide in the central section 75 and moves through a thermal swing provided by the heat exchanger 70 to a higher temperature at the discharge section 79, where the carbon absorber releases some of its load of dissolved gases, including carbon dioxide, nitrogen and oxygen. The released gases are labeled as exiting the discharge section 79 via the pipe 109. In this example, the carbon dioxide concentration is 400 ppm at 15° C. at the central section 75 and the concentration of the carbon dioxide after the release at 40° C. from the discharge section 79 is 2000 ppm at the pipe 109. The gas in the pipe 109 is cooled to 15° C. as it flows towards the first low section 100, as indicated by reference numeral 107, and injected to the gas flow in the pipe 106, that is also at a carbon dioxide concentration of 2000 ppm. The resulting gas flows into the low section 100, in which the high surface area facilitates an interaction between the gas and fluid similar to that which occurred at the central section 75 and the discharge section 79, such that the fluid that is circulated in the first low section 100 can become saturated with carbon dioxide.

The gas that leaves the first low section 100, via the pipe 99, has a carbon dioxide concentration of 400 ppm. This is injected back into the gas flow that is between the third target gas release section 74 and the central section 75, which also has a carbon dioxide concentration of 400 ppm.

The carbon dioxide-saturated fluid that leaves the first low section 100, is passed through the thermal swing provided by the heat exchanger 112, to 40° C. to the first high section 98. As per the other sections, the first high section has a high fluid surface to gas arrangement, such that the fluid can release carbon dioxide as it is oversaturated with respect to carbon dioxide at this temperature. The depleted fluid from the first high section 98 is cooled back to 15° C. and returned to the first low section 100 to reabsorb more carbon dioxide, and is thereby recycled.

The gas that is released from the first high section 98 has a carbon dioxide concentration of 10,000 ppm. The released gas, flowing through the pipe 108, is cooled to 15° C. and is injected into the flowing gas stream in the pipe 105 through which gas flows from the third low section 102 to the second low section 101, that is also at a carbon dioxide concentration of 10,000 ppm. The resulting gas flows into the second low section 101, where there is an arrangement providing a high surface area interaction between the gas and fluid similar to that in other sections. Thus the fluid that is circulated in the second low section 101 can become saturated with carbon dioxide. The gas that leaves the second low section 101, via the pipe 106, has a carbon dioxide concentration of 2000 ppm.

The carbon dioxide-saturated fluid that leaves the second low section 101, is passed through a thermal swing, provided by the heat exchanger 110, to 40° C. and into the second high section 96, where a high fluid surface to gas arrangement exists such that the fluid can release carbon dioxide as it is oversaturated at this temperature. The depleted fluid from the second high section 96 is cooled back to 15° C. and returned to the second low section 101 to reabsorb more carbon dioxide, and is thereby recycled.

The gas that is released from the second high section 96 has a carbon dioxide concentration of 50,000 ppm. The released gas flows through the pipe 104, and is cooled to 15° C. and passed into the third low section 102, where there is an arrangement providing a high surface area interaction between the gas and fluid similar to that which occurred in the central section 75 and the discharge section 79, such that the fluid that is circulated in the third low section 102 can become saturated with carbon dioxide. The carbon dioxide-saturated fluid that leaves the third low section 102 is passed through a thermal swing, provided by the heat exchanger 111, to 40° C. and passed to the third high section 97, where a high fluid surface to gas arrangement exists such that the fluid can release carbon dioxide as it is oversaturated at this temperature. The depleted fluid from the third high section 97 is cooled back to 15° C. and returned to the third low section 102 to reabsorb more carbon dioxide, and is thereby recycled.

The gas released from the third high section 97 has a carbon dioxide concentration of 250,000 ppm. The released gas is cooled to 15° C. by the heat exchanger at 116 and is then passed through the fourth, fifth and sixth target gas capture sections 80, 81 and 82 where, in general terms, in these sections, pumped fluids that are under saturated with respect to the carbon capture sorbent (methanol) and water vapour are placed in high surface area contact with the gas. This removes undesired levels of the carbon dioxide capture sorbent (methanol) and water vapour from the gas stream such that the gas that leaves the sixth gas capture section 82 at 83 has the desired levels of carbon capture sorbent i.e. virtually zero.

In more detail, in the fourth target gas capture section 80, absorbent (methanol) is pumped from the third target gas release section 74, via the pipe 89, into the fourth target gas capture section 80. The fluid in this section is depleted in respect to water and carbon capture sorbent (methanol) and this fluid is used to capture water vapour and sorbent (methanol) vapour from the gas stream coming in from the third high section 97 via the heat exchanger 116. The fluid that is saturated in respect to carbon capture sorbent (methanol) and water is then collected and passed to the third target gas release section 74, via the pipe 94 to deplete the fluid with respect to water and carbon capture sorbent.

The detailed fluid flow for the fifth target gas capture section 81 is to pump absorbent from the second target gas release section 73, via the pipe 90, which fluid is depleted with respect to water and carbon capture sorbent (methanol), and use this to capture water vapour and sorbent (methanol) vapour from the gas stream that leaves the fourth target gas capture section 80. The fluid, that is at that stage saturated with respect to carbon capture sorbent and water, is then collected and passed via the pipe 93, to the second target gas release section 73, to deplete the fluid with respect to water and carbon capture sorbent (methanol).

The detailed fluid flow for the sixth target gas capture section 82 is to pump absorbent from the first target gas release section 72, via the pipe 91, which fluid is depleted with respect to water and carbon capture sorbent, and use this to capture water vapour and sorbent (methanol) vapour from the gas stream that leaves the fifth target gas capture section 81. The fluid, that is at that stage saturated with respect to carbon capture sorbent and water, is then collected and passed, via the pipe 92, to the first target gas release section 72, to deplete the fluid with respect to water and carbon capture sorbent (methanol).

The concentration of water vapour which exits the system out of the first target gas capture section 78 is substantially the same as that which entered at 71.

The volume of gas decreases as the concentration of carbon dioxide increases. This means that the volume of gas reduces moving from the third low section 102, to the second low section 101, to the third low section 100. The concentration of carbon dioxide eventually exiting the system out of the sixth target gas capture section 82 at 83 will also depend on the gas flow rate and the concentration that entered at 1. The figures in the embodiment above are illustrative of many possibilities.

This example would also work with the alternative configuration described with respect to FIG. 2, namely where the fourth target gas capture section 80 is connected to the third target gas release section 74, the fifth target gas capture section 81 to the second target gas release section 73 and the sixth target gas capture section 82 to first target gas release section 72.

Thus it can be understood that in this embodiment, methanol and water vapour are target gases and carbon dioxide is a captured gas. Such captured carbon dioxide can either be sequestered or used in any application which requires a carbon dioxide input, since the ability to concentrate the carbon dioxide results in a substantially pure stream of carbon dioxide, free of the target gases. It will be understood that the system and process would work equally well with other target and captured gases. For example, the target gas could be one or more of ammonia, water vapour, methanol, ethanol or other organic or non-organic solvent or compound. Equally, the fluid would be a corresponding fluid, such as ammonia, water, methanol or other organic or non-organic solvent or compound.

The gas containment systems described in this invention will have numerous other applications and variations that follow from the detail outlined in this document. The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A process for capturing a target gas from a flowing gas mixture by use of at least a pair of capture and release sections together with a discharge section, said at least one pair of capture and release sections including a target gas capture section and a target gas release section in fluid communication with one another, said target gas discharge section being in fluid communication with the target gas capture section, the capture, release and discharge sections having a high surface area medium and a fluid contained therein and including a fluid entry point at a first end and a collection tank at a second end, said process comprising:
directing a gas mixture through the target gas release section followed by the target gas capture section, wherein the fluid contained within the pair of capture and release sections allows for the target gas to be contained within a defined area between the capture and release sections;
directing fluid through a first recirculation path from the collection tank of the target gas capture section to the entry point of the target gas release section and directing fluid from the collection tank of the target gas release section to the entry point of the target gas capture section, thereby recycling the fluid, said pair of capture and release sections including a concentration gradient of at least one of the target gas and the fluid;
directing the fluid through a flow path, from the collection tank of the target gas capture section, heating the fluid and passing it through the discharge section to thereby release the target gas from the fluid within the discharge section due to the reduced solubility; and
directing the fluid depleted of the target gas through a second recirculation path from the collection tank of the discharge section and then to the entry point of the capture section.

2. The process of claim 1 where one or more further gases are captured.

3. The process of claim 2 where the flowing gas mixture is natural gas and carbon dioxide or methane and carbon dioxide, and carbon dioxide is the captured gas and the fluids used to capture the carbon dioxide comprise a solution of a target gas or gases contained by the process.

4. The process of claim 1, wherein the discharged gas is directed through a series of gas capture sections that are in fluid connection with the target gas capture sections so that any target gas or gases that are discharged are removed such that a stream of captured gas or gases that is substantially free of the target gases is achieved.

5. The process of claim 4, wherein one or more heat exchangers are placed between the gas capture section and the captured gas release section and/or between the captured gas release section and the target gas capture section to remove and recover heat.

6. The process of claim 1, wherein the gas mixture is at constant temperature and pressure.

7. The process of claim 1, wherein the fluid comprises one of water, ammonia, methanol, ethanol or any other organic fluid and solutions thereof and, mixtures thereof.

8. The process of claim 1, wherein the target gas comprises one of ammonia, water vapour, CO2 or organic solvents.

9. The process of claim 1, wherein a target gas is water vapour and the fluid is comprised of a solution that has a relative humidity which allows gas to be discharged at substantially the same given percent relative humidity at which it entered the process.

10. The process of claim 1, further comprising directing the gas through a further flow path in which the concentration of a gas to be captured is increased.

11. The process of claim 10, wherein the further flow path comprises one or more thermal swings, arranged to increase the concentration of the gas to be captured.

12. The process of claim 11, further comprising providing the one or more thermal swings using fluid in one or more further recirculation paths.

13. The process of claim 10, further comprising directing the gas from the further flow path into the gas capture section, such that a stream of captured gas or gases that is substantially free of the target gases is achieved.

14. An apparatus for capturing a target gas from a flowing gas mixture, comprising:
at least a pair of capture and release sections and a discharge section, said at least one pair of capture and release sections including a target gas capture section and a target gas release section in fluid communication with one another, said target gas discharge section being in fluid communication with the target gas capture section, wherein the capture, release and discharge sections have a high surface area medium and a fluid contained therein and include a fluid entry point at a first end and a collection tank at a second end;
a defined area between the capture and release sections, wherein the fluid contained within the pair of capture and release sections allows for the target gas to be contained within the defined area upon a gas mixture being directed through the target gas release section followed by the target gas capture section;
a first recirculation path through which fluid can be directed from the collection tank of the target gas capture section to the entry point of the target gas release section and from the collection tank of the target gas release section to the entry point of the target gas capture section, thereby recycling the fluid, said pair of capture and release sections including a concentration gradient of at least one of the target gas and the fluid;
a flow path through which fluid can be directed from the collection tank of the target gas capture section through the discharge section;
a means for heating the fluid in the discharge section to thereby release the target gas from the fluid within the discharge section due to the reduced solubility; and
a second recirculation path from the collection tank of the discharge section to the entry point of the capture section, through which fluid depleted of the target gas can be directed.

15. The apparatus of claim 14, arranged to capture one or more further gases.

16. The apparatus of claim 15, arranged to capture a target gas from a flowing gas mixture which is natural gas and carbon dioxide or methane and carbon dioxide, and wherein carbon dioxide is the captured gas and the fluids used to capture the carbon dioxide comprise a solution of a target gas or target gases contained by the process.

17. The apparatus of claim 14, further comprising a series of capture sections that are in fluid connection with the target gas capture sections, through which the discharged gas can be directed so that any target gas or gases that are discharged are removed such that a stream of captured gas or gases that is substantially free of the target gases is achieved.

18. The apparatus of claim 17, further comprising one or more heat exchangers placed between the gas capture section and the captured gas release section and/or between the captured gas release section and the target gas capture section to remove and recover heat.

19. The apparatus of claim 10, wherein the gas mixture is at constant temperature and pressure.

20. The apparatus of claim 14, wherein the fluid comprises one of water, ammonia, methanol, ethanol or any other organic fluid and solutions thereof and, mixtures thereof.

21. The apparatus of claim 14, wherein the target gas comprises one of ammonia, water vapour, CO2 or organic solvents.

22. The apparatus of claim 14, wherein a target gas is water vapour and the fluid is comprised of a solution that which allows gas to be discharged at substantially the same given percent relative humidity at which it entered the apparatus.

23. The apparatus of claim 14, further comprising a further flow path arranged for gas to be directed through, such that the concentration of a gas to be captured is increased.

24. The apparatus of claim 23, wherein the further flow path comprises one or more thermal swings, arranged to increase the concentration of the gas to be captured.

25. The apparatus of claim 24, wherein the one or more thermal swings comprise a heat exchanger and a fluid recirculation path.

26. The apparatus of claim 23, arranged for directing gas from the further flow path into the gas capture section, such that a stream of captured gas or gases that is substantially free of the target gases is achieved.

27. The apparatus of claim 23, wherein the further flow path comprises a connection between the discharge section and the one or more thermal swings.

28. A process for capturing a target gas from a flowing gas mixture by use of at least a pair of capture and release sections together with a discharge section, said at least one pair of capture and release sections including a target gas capture section and a target gas release section in fluid communication with one another, said target gas discharge section being in fluid communication with the target gas capture section, the capture, release and discharge sections having a high surface area medium and a fluid contained therein and including a fluid entry point at a first end and a collection tank at a second end, said process comprising:
directing a gas mixture through the target gas release section followed by the target gas capture section, wherein a target gas is water vapour and the fluid contained within the pair of capture and release sections is comprised of a solution which allows for water vapour to be contained within a defined area between the capture and release sections;
directing fluid through a first recirculation path from the collection tank of the target gas capture section to the entry point of the target gas release section and directing fluid from the collection tank of the target gas release section to the entry point of the target gas capture section, thereby recycling the fluid, said pair of capture and release sections including a concentration gradient of at least one of water vapour and the fluid;
directing the fluid through a flow path, from the collection tank of the target gas capture section, and passing it through the discharge section to thereby release water vapour from the fluid within the discharge section; and
directing the fluid depleted of the water vapour through a second recirculation path from the collection tank of the discharge section and then to the entry point of the capture section,
wherein gas is discharged at substantially the same given percent relative humidity at which the gas mixture entered the process.

29. An apparatus for capturing a target gas from a flowing gas mixture, comprising:
at least a pair of capture and release sections and a discharge section, said at least one pair of capture and release sections including a target gas capture section and a target gas release section in fluid communication with one another, said target gas discharge section being in fluid communication with the target gas capture section, wherein the capture, release and discharge sections have a high surface area medium and a fluid contained therein and include a fluid entry point at a first end and a collection tank at a second end;
a defined area between the capture and release sections, wherein a target gas is water vapour, and wherein the fluid contained within the pair of capture and release sections allows for water vapour to be contained within the defined area upon a gas mixture being directed through the target gas release section followed by the target gas capture section;
a first recirculation path through which fluid can be directed from the collection tank of the target gas capture section to the entry point of the target gas release section and from the collection tank of the target gas release section to the entry point of the target gas capture section, thereby recycling the fluid, said pair of capture and release sections including a concentration gradient of at least one of water vapour and the fluid;
a flow path through which fluid can be directed from the collection tank of the target gas capture section through the discharge section; and
a second recirculation path from the collection tank of the discharge section to the entry point of the capture section, through which fluid depleted of water vapour can be directed,
wherein in use, gas is discharged at substantially the same given percent relative humidity at which the gas mixture entered the process.
